(19) United States
(12) Patent Application Publication
(10) Pub. No.: US 2024/0330674 A1
(43) Pub. Date: Oct. 3, 2024

(54) VIRTUAL TRAINING METHOD FOR A NEURAL NETWORK FOR ACTUATING A TECHNICAL DEVICE

(71) Applicant: dSPACE GmbH, Paderborn (DE)

(72) Inventor: Steffen Grotenhoefer, Paderborn (DE)

(21) Appl. No.: 18/190,187

(22) Filed: Mar. 27, 2023

(51) Int. Cl. G06N 3/08

(52) U.S. Cl. CPC G06N 3/08

(57) ABSTRACT

The invention relates to a method for training a neural network for actuating a technical device, in a virtual training environment. The method comprises establishing a first data link between the neural network and a first simulation of the technical device, and then training the neural network by actuating the first simulation. Once a first training goal has been achieved, the first data link is broken and a second data link is established between the neural network and a second simulation of the technical device in order to train the neural network by actuating the second simulation. The second simulation is configured to be more realistic than the first simulation and requires more mathematical operations for a simulation cycle owing to its higher degree of realism.

### BACKGROUND

Recently, neural networks have brought about huge progress in the development of autonomous systems that can independently carry out complex movement patterns or monitoring tasks in a changing environment. The problem in this respect, however, is the large volume of training data required in order to sufficiently train a neural network, particularly when the neural network is intended for a safety-critical task in which a false recognition can have disastrous consequences. Examples include a self-driving vehicle intended for road traffic, a smart monitoring camera that recognizes people drowning in a lake, or a rescue robot that searches areas or buildings for injured people. Not only do systems of this kind require particularly large volumes of diverse training data in order to optimally rule out malfunctions caused by too little or too one-sided training, but the training data also have to contain large volumes of data that depict disastrous or critical scenarios that the neural network is to be trained to reliably recognize and process. Since these scenarios, by their very nature, only occur rarely, corresponding data collections are also rare, meaning that collecting enough training data represents a huge amount of work.

One known solution to this problem from the prior art is to generate synthetic training data using computer simulation. In this case, scenarios for training a neural network are reconstructed in a virtual environment, and training data are generated on the basis of the reconstructed scenarios, in a form that the neural network can understand. In this way, virtual scenarios can be easily varied as desired. Generally, though, the synthetic data do not perfectly recreate the real-world data, so there is a risk in principle that the neural network becomes accustomed to the synthetic training data and is inadequately trained for real-world use.

The scientific paper “Synthetic Data for Deep Learning,” Sergey I. Nikolenko (2019), contains a comprehensive overview of relevant prior art. The paper sets out different examples of neural networks that have been successfully trained in virtual environments. These are, however, academic studies that merely demonstrate that it is possible to do so in principle. This does not change the fact that the more realistic the synthetic training data, the more reliable a neural network trained using those synthetic data.

### SUMMARY

In an exemplary embodiment, the present invention provides a computer-implemented method for training a neural network for actuating a technical device. The method includes: establishing a first data link between the neural network and a first virtual simulation of the technical device via a first data interface of the first simulation for reading out status data from the first simulation and transferring control data to the first simulation; setting a first training goal for an actuation of the first simulation; training the neural network based on the first simulation being actuated by the neural network, and checking the training progress of the neural network against the first training goal; breaking the first data link based on the first training goal having been achieved, and then establishing a second data link between the neural network and a second virtual simulation of the technical device, wherein the second simulation is configured to be more realistic than the first simulation and requires more mathematical operations than the first simulation for a respective simulation cycle owing to its higher degree of realism, and wherein the second data link is established via a second data interface of the second simulation for reading out status data from the second simulation and transferring control data to the second simulation; and training the neural network based on the second simulation being actuated by the neural network.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of a virtual training environment;

FIG. 2 is a flowchart of a training operation;

FIG. 3 shows a virtual environment for a simulation of a highly automated vehicle;

FIG. 4 shows a sensor simulation for simulating lane recognition in the highly automated vehicle;

FIG. 5 shows a first simulation of the highly automated vehicle;

FIG. 6 shows a second simulation of the highly automated vehicle; and

FIG. 7 shows a third simulation of the highly automated vehicle.

### DETAILED DESCRIPTION

The invention relates to training neural networks for actuating a technical device via synthetic training data. In this case, if the technical device is one subject to stringent safety requirements, for example a highly automated vehicle, then synthetic training data with a high degree of realism have to be used for the training in order to ensure that the capabilities of the neural network that were learned in the virtual environment can be carried over to the real world. Accordingly, it would be advantageous to provide a virtual simulation of the technical device that gives the neural network an outstanding, almost perfect illusion that it is actuating the technical device in the real world. However, the realism of a simulation model is inversely proportional to its execution speed, since the more technical components of the device and physical phenomena and interactions are taken into account in the simulation, the more realistically a simulation model of a technical device behaves. Thus, the desire for the highest possible degree of realism conflicts with the desire for the quickest possible execution speed of the simulation in order to bring the training to an end within a reasonable timeframe.

Exemplary embodiments of the invention speed up the training of a neural network for actuating a technical device in a virtual training environment.

The patent publication U.S. Pub. No. 2022/009510 A1 proposes a training method that begins in a purely virtual training environment and gradually replaces the virtual training environment with a real-world training environment in order to gradually accustom the neural network to the more complex real world in the later training phases. Although the method allows a relatively simple simulation to be used, the later training phases are reliant on real-world training data, which have the associated drawbacks mentioned above.

Exemplary embodiments of the invention provide a method for training a neural network for actuating a technical device, as well as a virtual training environment for carrying out the method. According to the invention, a first data link is established between a neural network to be trained and a first simulation of the technical device. For this purpose, the first simulation is equipped with a first data interface, via which the neural network can read out status data from the first simulation and transfer control data to the first simulation.

Preferably, the first data interface recreates a real-world data interface of the technical device, the neural network being intended to use said data interface for actuating the real-world technical device once its training is complete and validated. Status data should be construed as data which give the neural network information on a current status of the technical device and utilized by the neural network in order to actuate the technical device. Control data should be construed as data that are suitable for changing the current status of the technical device toward a target status of the technical device specified by the neural network. If the technical device is a land-based vehicle, for example, then examples of possible status data are a distance from a line marking the side of the road, a speed of the vehicle, a distance from a vehicle in front, an engaged gear, a roll angle of the vehicle, or a description of the surroundings of the vehicle, and examples of possible control data are a steering angle, opening of a throttle valve, or a braking power.

In addition, a first training goal for an actuation of the first simulation is set, and the neural network is trained by the first simulation being actuated by the neural network, the training progress of the neural network being regularly checked against the first training goal.

According to the invention, the training of the neural network using the first simulation is continued until the neural network achieves the first training goal. Once the first training goal has been achieved, the first data link is broken and a second data link is established between the neural network and a second virtual simulation. The second simulation is configured to be more realistic than the first simulation and requires more mathematical operations than the first simulation for a simulation cycle owing to its higher degree of realism. The second data link is established via a second data interface of the second simulation for reading out status data from the second simulation and transferring control data to the second simulation.

A simulation cycle refers to a complete execution of a simulation step, in particular a time step, of a simulation.

According to the invention, a relatively simple but, in return, fast simulation model of the technical device is thus used in the early phase of the training. As soon as the neural network satisfactorily masters the actuation of the simple simulation model, as indicated by the training goal being achieved, the simple simulation model is replaced with a more complex and slower but, in return, more realistic simulation model, and the training is continued by the second simulation being actuated by the neural network.

An underlying assumption of the invention is that the simulation model need not be very realistic in the early training phases because at this time the neural network is still working on learning the basics. For an example explanation, the neural network is to be trained to steer a self-driving road vehicle on the basis of a method according to the invention. The untrained neural network would first need to understand what its task actually involves (keeping the vehicle between the right-hand edge marking and the center line) and how to master this task in basic terms (a negative steering angle makes the vehicle drive left, a positive steering angle makes it drive right).

A very simple simulation of the vehicle is sufficient for learning these basics. As soon as the neural network has satisfactorily learned them, the first simulation is replaced with a second simulation of the vehicle, which takes account of more complex phenomena, for example the roll angle, instability on bends, driving comfort, skidding conditions, or crosswind. A concept of the invention is a special application of the so-called ‘transfer learning,’ in which a pre-learned capability of a neural network is used as an advantage for learning another capability (in this case: actuating a more realistic simulation). In training scenarios in which for safety reasons very complex, realistic simulations have to be used for the training, the invention leads to significant time savings.

Advantageously, a second training goal for an actuation of the second simulation is set, and the neural network is trained by actuating the second simulation until the second training goal has been achieved. For this purpose, during the actuation of the second simulation, the training progress of the neural network is checked against the second training goal. The second training goal may be identical to the first training goal or be different from the first training goal. Once the second training goal has been achieved, the training can be considered complete, and a physical data link can be established between the neural network and the technical device in the real world in order to validate the training of the neural network in the real world. It will be appreciated, however, that it is also possible to continue the training in the virtual training environment before real-world validation by actuating a third simulation and any number of further simulations of the technical device, the realism of each simulation of the technical device being greater than the previous simulation in each case. The termination of the actuation of a simulation once the relevant training goal has been achieved and the transition to the actuation of the relevant next simulation occur in each case similarly to as explained with regard to the example of the first simulation and the second simulation.

The first data interface and the second data interface are preferably configured identically such that the first data link can be replaced with the second data link immediately and without modifying the data exchange operated by the neural network.

Simulating the technical device advantageously comprises generating simulated sensor data, which contain information on a virtual environment of the technical device. Of course, the nature of these sensor data depends on the technical device and on the task which the neural network is trained to accomplish. By way of example, the sensor data can be an object list generated on the basis of simulated moving or static objects in the virtual environment, lane boundaries, a polygon-based recreation of surfaces in the environment, or raw data from an image-generating sensor, in particular from a camera, a lidar, a radar, or an echolocation. The virtual sensor data are transferred to the neural network, and the neural network is trained to evaluate the sensor data and to take them into account when actuating the relevant simulation and ultimately the technical device.

It will be appreciated that the simulated sensor data is generated in a format that the neural network can understand, in particular in the same format in which the real-world sensor data are also available in the technical device. Solutions for plausibly simulating sensor data on the basis of a virtual environment are available in the prior art; see for example the scientific paper “Development of Full Speed Range ACC with SiVIC, a virtual platform for ADAS Prototyping, test and evaluation,” Dominique Gruyer et al., IEEE Intelligent Vehicle Symposium (2013).

In a further embodiment of the invention, it is also possible to make changes to the virtual environment concurrently in order to increase the complexity of the simulation of the technical device. These may be purely geometric changes to ensure that the neural network learns to generalize instead of simply learning movement patterns in a specific virtual environment by heart. However, the changes can also be expansions to the virtual environment that have a fundamental impact on the behavior of the simulation of the technical device, making the behavior of the simulation more realistic and possibly more demanding for the neural network.

The technical device is preferably a robot. A robot should be construed as any apparatus that, via actuation by a computer, in particular also by the neural network, is given the ability to perform an independent, complex movement pattern in order to carry out a predefined activity. In particular, the technical device may be an at least partially automated landcraft, watercraft, or aircraft, a robot arm, a robot for placing or attaching material and/or objects, for cleaning surfaces, for examining spaces or surfaces, for applying a chemical, for example a cleaning agent, a disinfectant, a paint, a varnish, or a coating, for carrying out a medical intervention, or any combination of the aforementioned categories of robots.

The training goal can also be configured differently depending on the type of technical device and the task that the neural network is to learn. For example, it may be a predefined stretch traveled on a virtual training course or a virtual test route, a predefined number of movement patterns carried out without any collisions or within a predefined movement range, a predefined time period within which the neural network actuates the first simulation properly and without any undesired events occurring, or a predefined threshold value being reached for a reward function on the basis of which the neural network is trained. Reward functions are regularly used to train neural networks in order to assess, during the training, whether an output of a neural network constitutes an improvement over earlier training phases. Reward functions are defined such that the result thereof can show how well a neural network has mastered its particular task. Neuron and synapse configurations that have led to an improvement are retained as a basis for further training steps, and configurations that have led to an impairment are rejected.

There are different options for configuring a second simulation to be more realistic than a first simulation. For example, the second simulation can take account of more mechanical and/or electrical components of the technical device than the first simulation, it can take account of more mechanical degrees of freedom, it can simulate physical phenomena and laws more realistically or to a higher degree of accuracy, it can take account of a greater number of physical forces or interactions, or can have a smaller simulation step size.

The drawings and the following description thereof explain the invention in more detail on the basis of a specific example.

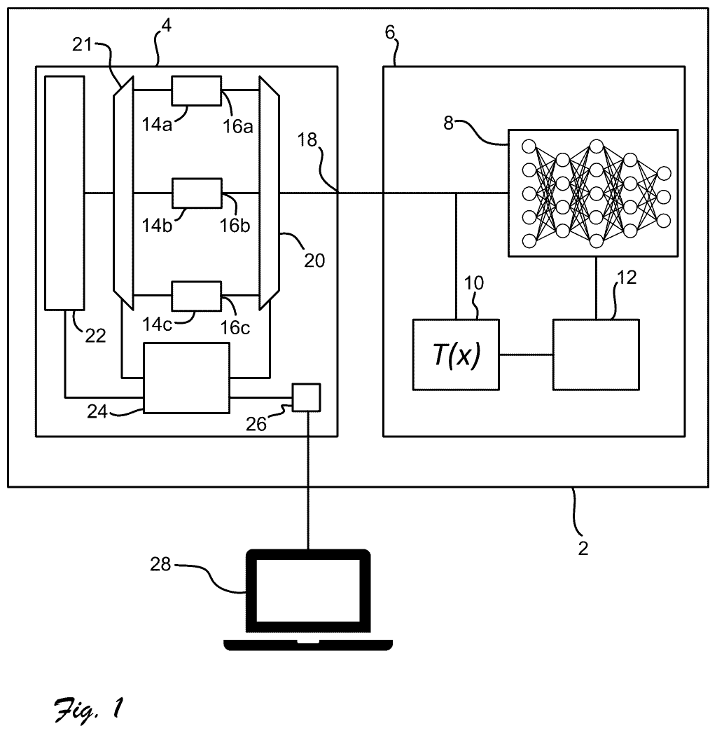

The drawing in FIG. 1 shows a computer system 2 on which a virtual training environment 4 and a development environment 6 for a neural network 8 are set up. A neural network 8 intended for actuating a technical device and to be trained for that task is embedded in the development environment 6. The development environment 6 is logically separated from the training environment 4 and comprises, in addition to the neural network 8, a first development routine 10 for executing a reward function T and a second development routine 12 configured to monitor the function value of the reward function T and to change the configuration of the neural network 8 on the basis of the function value, i.e., to change the values stored in the neurons and synapses of the neural network 8 in order to optimize the function value of Tin a predefined way. The function value of T depends on a matrix x, the entries in which are supplied by the virtual training environment 4.

Development environments such as the development environment 6 shown are known in the prior art and available on the market. Examples include PyTorch and Tensorflow.

By way of example, the virtual training environment 4 comprises three simulations of the technical device: a first simulation 14a, a second simulation 14b, and a third simulation 14c. The first simulation 14a comprises a first data interface 16a for the neural network 8 to actuate the first simulation 14a. While being trained on the first simulation 14a, the neural network 8 reads status data from the first simulation 14a and transfers control data to the first simulation 14a. Similarly, the second simulation 14b comprises a second data interface 16b, and the third simulation 14c comprises a third data interface 16c. Both the second data interface 16b and the third data interface 16c are functionally identical to the first data interface 16a. As a result, the three simulations 14a, 14b, 14c can be immediately swapped for one another, and the neural network 8 cannot directly discern which of the three simulations 14a, 14b, 14c it is actuating.

The simulations of the technical device have an increasing degree of realism, i.e., the second simulation 14b is configured to be more realistic than the first simulation 14a, and the third simulation 14c is configured to be more realistic than the second simulation 14b. As a result of their respective higher degrees of realism, a simulation cycle of the second simulation 14b requires more mathematical operations to be executed by the computer system 2 than a simulation cycle of the first simulation 14a, making the second simulation 14b slower than the first simulation 14a, and a simulation cycle of the third simulation 14c requires more mathematical operations to be executed by the computer system 2 than a simulation cycle of the second simulation 14b, making the third simulation 14c even slower than the second simulation 14b.

The virtual training environment 4 comprises a first virtual multiplexer 20 for establishing a data link between one of the three simulations 14a, 14b, 14c and a programming interface 18 of the virtual training environment 4. Via the programming interface 18, the development environment 6 is connected to the training environment 4 such that, as a result of the positioning of the first virtual multiplexer 20, a first data link can be established between the neural network 8 and the first simulation 14a, or a second data link can be established between the neural network 8 and the second simulation 14b, or a third data link can be established between the neural network 8 and the third simulation 14c.

As well as the simulations 14a, 14b, 14c of the technical device, the virtual training environment 4 also comprises a virtual environment 22 of the technical device, and a second virtual multiplexer 21 is configured to establish a data link between the virtual environment 22 and one of the simulations 14a, 14b, 14c. The virtual environment 22 is a recreation of a typical environment of the technical device, and one of the three simulations 14a, 14b, 14c is incorporated in the virtual environment 22, on the basis of the data link established by the second virtual multiplexer 21, in such a way that the training environment 4 can take account of interactions between the relevant simulation 14a, 14b, 14c and the virtual environment 22 that simulate typical interactions of the technical device with a real-world environment. The first simulation 14a, the second simulation 14b, and the third simulation 14c each also include at least one sensor simulation 30, which simulates a real-world sensor of the technical device, for generating simulated sensor data 34, from which the neural network 8 can read out information on the virtual environment 22, and for transmitting the simulated sensor data to the neural network 8.

A training functionality 24 is configured to actuate the first virtual multiplexer 20 and the second virtual multiplexer 22 in such a way that both multiplexers are connected to the same simulation 14a, 14b, 14c of the technical device at any one time, such that at any one time there is a continuous, indirect data link between the virtual environment 22 and the neural network 8, via the first simulation 14a, the second simulation 14b, or the third simulation 14c. In addition, the training functionality 24 is configured to read out, from a training goal memory 26, a first training goal for the first simulation 14a, a second training goal for the second simulation 14b, and a third training goal for the third simulation 14c. An operator computer 28 comprising configuration software is connected to the computer system 2 such that the first training goal, the second training goal, and the third training goal can be set by a user and stored in the training goal memory 26 via an operator interface of the configuration software.

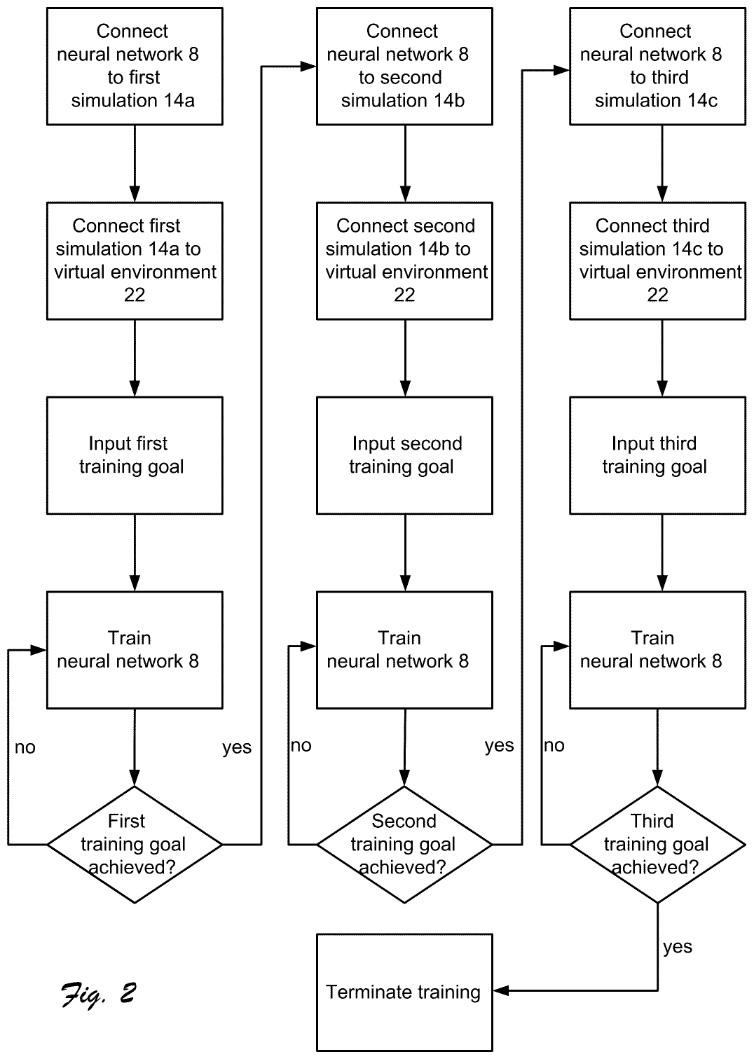

The drawing in FIG. 2 shows method steps that the training functionality 24 carries out in order to train the neural network 8. At the start, the training functionality 24 connects the first simulation 14a to the neural network 8 by actuating the first virtual multiplexer 20, thereby establishing the first data link. Next, the training functionality 24 connects the first simulation 14a to the virtual environment 22 by actuating the second virtual multiplexer 21. Thus, the training functionality has established a continuous data link, mediated by the first simulation 14a, between the neural network 8 and the virtual environment 22, and the neural network 8 can actuate the first simulation 14a in the virtual environment 22. At this juncture, the training functionality 24 launches the training of the neural network 8 by the first simulation 14a being actuated by the neural network 8, checks the training progress of the neural network 8 against the first training goal continually during the training, and continues the training until the first training goal has been achieved.

Due to the high run speed of the first simulation 14a, the first training goal is achieved in a relatively short time. Advantageously, the configuration of the first simulation 14a and the first training goal are selected such that the neural network 8 has learned the basics of actuating the technical device once the first training goal has been achieved.

Once the first training goal has been achieved, the training functionality 24 connects the neural network 8 to the second simulation 14b by actuating the first virtual multiplexer 20. In this way, the training functionality 24 breaks the first data link and replaces the first data link with a second data link between the neural network 8 and the second simulation 14b. Next, the training functionality 24 connects the second simulation 14b to the virtual environment by actuating the second virtual multiplexer 21. The second simulation is now incorporated in the virtual environment 22 in the same way and can be actuated by the neural network 8 in the same way as the first simulation 14a was previously. Similarly, the training functionality 24 launches and monitors the training and continues the training until the second training goal has been achieved. Similarly again, a third training phase involving the third simulation 14c is carried out until the third training goal has been achieved. Achieving the third training goal causes the training functionality 24 to terminate the training.

The third and final simulation 14c is preferably a very complex and realistic simulation of the technical device, and the third training goal and the configuration of the third simulation are preferably selected such that, once the third and final training goal has been achieved, the neural network 8 has learned how to safely actuate the technical device even under rare exceptional conditions.

Once the training has been terminated in the virtual training environment 4, a data link can be established between the neural network and the technical device in order for the technical device to be actuated by the neural network 8 in a real-world environment, either for validating the training carried out in the virtual training environment 4 or to continue therewith in a real-world environment.

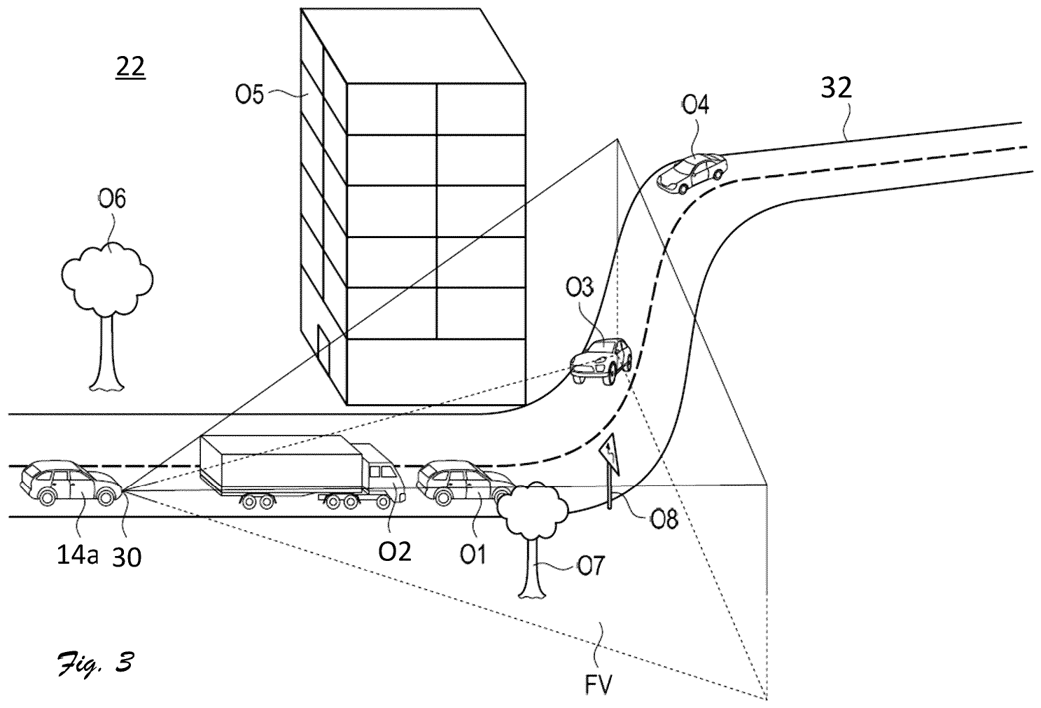

The drawing in FIG. 3 shows a virtual training environment for training neural networks for actuating a highly automated road vehicle. The virtual environment 22 recreates a typical environment of a highly automated road vehicle and for this purpose comprises a multitude of static and moving 3D objects O1, . . . , O8 such as vehicles, vegetation, traffic signs, and buildings, plus a virtual test route 32 that recreates a road. In the example shown, the technical device is a road vehicle, and a first simulation 14a of the road vehicle is incorporated in the virtual environment 22 as a virtual road user, such that the first simulation 14a moves in the virtual environment 22 in the same way as a real-world road vehicle in a real-world road traffic scenario.

The first simulation 14a (and also the second simulation 14b and the third simulation 14c) comprises a sensor simulation 30, to which a sensor position is assigned in the virtual environment 22 (on the front of the simulated road vehicle 14a in the case shown). By way of example, the sensor simulation 30 simulates a smart camera for recognizing lanes. In the virtual environment 22, the sensor simulation 30 is assigned a field of vision FV. Lanes are visible for the sensor simulation 30 as long as they are within the field of vision FV and are not concealed by 3D objects O1, . . . , O8 or the topography of the virtual environment 22 from the perspective of the sensor simulation 30.

The neural network 8 is to be trained in the virtual environment to steer the road vehicle 14a sideways by actuating the steering angle. Other aspects of actuating the road vehicle 14a, such as acceleration, braking, and distance control, are performed by routines of the first simulation 14a or of the second simulation 14b or of the third simulation 14c and are not subject to the influence of the neural network 8.

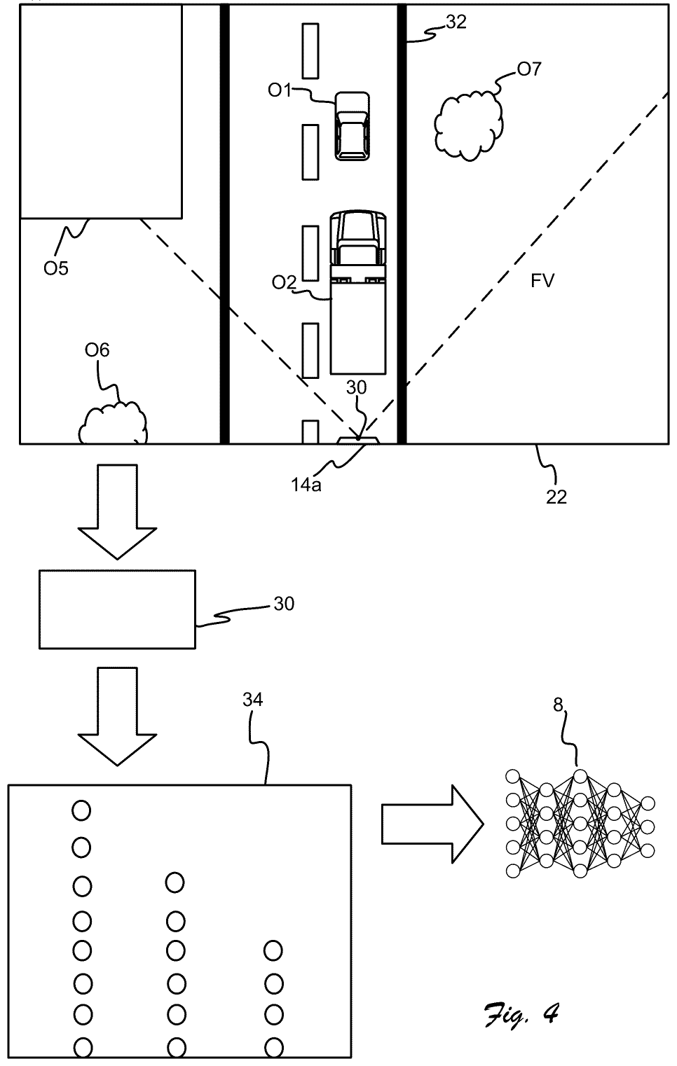

The drawing in FIG. 4 shows the functioning of the sensor simulation 30 by way of example. As an input, the sensor simulation 30 receives a description of the virtual environment 22 from the virtual training environment 4, for example in the form of an object list, generates simulated sensor data 34 from the description, and transmits the simulated sensor data 34 to the neural network 8 via the programming interface 18. In the example shown, the sensor data 34 consist of rows of spots, each row of spots representing a lane segment visible to the smart camera and each spot being represented by three spatial coordinates. The rows of spots specify a movement range for the simulated road vehicle 14a in the virtual environment 22. The first training goal of the neural network 8 for the first simulation 14a is to actuate the first simulation 14a such that the road vehicle simulated by the first simulation 14a travels a predefined stretch on the virtual test route 32, for example a five-kilometer stretch, without colliding with any of the spots from one of the rows of spots in the simulated sensor data 34 while on that stretch. For this purpose, the training functionality 24 is configured to monitor the route traveled on the virtual test route 32 by the road vehicle simulated by the first simulation 14a, and to recognize collisions of the road vehicle with roadway boundaries.

The rows of spots in the sensor data 34 are an example of so-called ground-truth sensor data. They simulate sensor data, as available after a smart evaluation of the raw data from an image-generating sensor, and are particularly simple to simulate on the basis of a virtual environment 22. In principle, however, the simulated sensor data 34 can be configured in any way depending on the type of sensor data 34 that the neural network 8 is to be trained to process, for example as an object list or as raw data from a camera, a thermal-imaging camera, a radar, a lidar, or an echolocation. The simulated sensor data 34 can also originate from a real-world camera pointed at a screen on which an image of the virtual environment 22 is rendered in real time from the perspective of the sensor simulation 30. A person skilled in the art can find an overview of the different options for the sensor simulation, and the breakpoints to be implemented therefor, in the scientific paper “Full spectrum camera simulation for reliable virtual development and validation of ADAS and automated driving applications,” Rene Molenaar et al., 2015 IEEE Intelligent Vehicles Symposium (IV), using the example of a camera simulation.

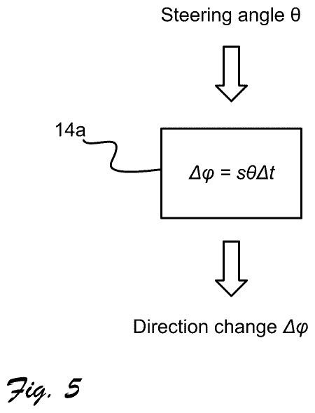

The drawing in FIG. 5 shows a possible configuration of the first simulation 14a of the road vehicle. As an input from the neural network 8, the first simulation receives a steering angle θ and assigns a direction change Δφ of the road vehicle on the two-dimensional plane of the virtual test route 32 to the steering angle θ on the basis of a simple linear function, through multiplication by a constant steering sensitivity s and the simulation step size Δt. On the basis of the direction change Δφ, the first simulation 14a computes the new direction of travel in the subsequent simulation step. The first simulation 14a is thus an extremely simplified model of the road vehicle, in which the road vehicle is a solid body without any degree of rotational freedom and at any one time moves in parallel with the ground on a perfect arc, the curvature of which is linearly predetermined by the steering angle θ. On the basis of the first simulation 14a, the neural network 8 learns the basics of steering the road vehicle.

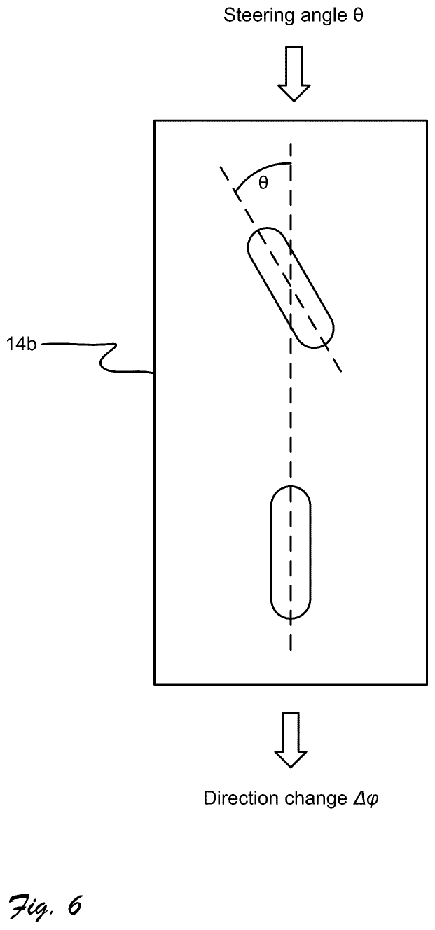

Once the first training goal has been achieved, the first simulation 14a is, as described above on the basis of FIG. 1, replaced with a second simulation 14b, which is shown in the drawing in FIG. 6. In exactly the same way as with the first simulation 14a, the second simulation receives a steering angle θ as an input from the neural network 8 and ascertains, on that basis, a direction change Δφ that is visible to the neural network 8 owing to the sensor data 34 transmitted to the neural network 8, the configuration of the sensor data 34 remaining unchanged compared with the first simulation 14a. The second data interface 16b, via which the neural network 8 reads out status data (in this case: sensor data 34) from the second simulation 14b and transfers control data (in this case: steering angle θ) to the second simulation 14b, is thus identical to the first data interface 16a of the first simulation. The neural network thus cannot directly discern that the first simulation 14a has been replaced with the second simulation 14b. However, the second simulation 14b is configured to be more realistic than the first simulation 14b, although the second simulation 14b is also still highly simplified compared with reality. The second simulation 14b is a so-called kinematic bicycle model, which is a basic model known to a person skilled in the art for the simple simulation of a four-wheeled land-based vehicle. The kinematic bicycle model combines each two wheels located at one level into one wheel, such that two wheels are arranged on a shared longitudinal axis, the front wheel being assigned a tilt angle in accordance with the steering angle θ from which the direction change Δp is calculated in cooperation with the fixed rear wheel. The kinematic bicycle model takes account of more degrees of freedom than the first simulation 14a, namely the ability of the front wheels to turn, as well as more physical phenomena, for example the extent of the vehicle in space or the existence of a center of mass of the vehicle. Thus, more mathematical operations have to be handled for a simulation cycle of the second simulation 14b than for a simulation cycle of the first simulation 14a. Overall, the training of the neural network 8 is thus slower compared with the training on the first simulation 14a. However, the second simulation 14b still disregards a multitude of phenomena, for example the loss of adhesion of the tires, and degrees of freedom of the vehicle. Thus, the second simulation 14b is also fast enough to achieve quick training successes even in the second training phase.

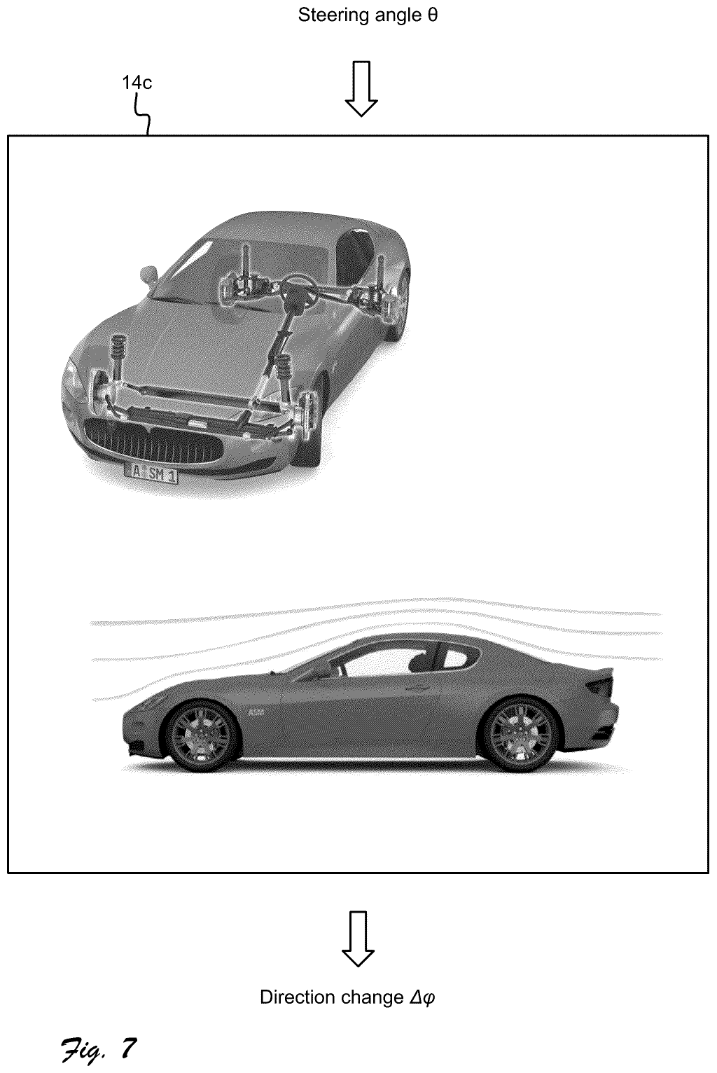

The second simulation 14b is assigned a second training goal, which may be identical to the first training goal. Once the training goal has been achieved, the second simulation 14b is, as described above, replaced with a third simulation 14c, which is shown in the drawing in FIG. 7. The third simulation 14c is a complex simulation that recreates the technical and mechanical operations in a real-world road vehicle to a high degree of detail. It includes a complete simulation of the drivetrain and of all suspensions of the vehicle, a simulation of the engine with realistic acceleration and braking behavior, a realistic tire model, yaw and roll movements of the vehicle when the bodywork is positioned on the road, loss of contact of some or all of the tires with the road, and aerodynamic forces acting on the vehicle. The third data interface 16c of the third simulation 14c is again identical to the second data interface 16c and to the first data interface 16a.

Owing to the high degree of detail in the third simulation 14c, the training with the third simulation 14c is considerably more time-consuming than with the second simulation 14b and the first simulation 14a, but the performance of the third simulation 14c is largely similar to the actual performance of a road vehicle. As a result, once the third training goal has been achieved, the neural network has reached a high training level and can experimentally actuate a real-world road vehicle on a real-world test route.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A computer-implemented method for training a neural network for actuating a technical device, comprising:
establishing a first data link between the neural network and a first virtual simulation of the technical device via a first data interface of the first simulation for reading out status data from the first simulation and transferring control data to the first simulation;
setting a first training goal for an actuation of the first simulation;
training the neural network based on the first simulation being actuated by the neural network, and checking the training progress of the neural network against the first training goal;
breaking the first data link based on the first training goal having been achieved, and then establishing a second data link between the neural network and a second virtual simulation of the technical device, wherein the second simulation is configured to be more realistic than the first simulation and requires more mathematical operations than the first simulation for a respective simulation cycle owing to its higher degree of realism, by and wherein the second data link is established via a second data interface of the second simulation for reading out status data from the second simulation and transferring control data to the second simulation; and
training the neural network based on the second simulation being actuated by the neural network.

2: The method according to claim 1, wherein the first data interface and the second data interface are configured identically.

3: The method according to claim 1, further comprising:
generating simulated sensor data which contain information on a virtual environment of the technical device;
transferring the simulated sensor data to the neural network; and
training the neural network to evaluate the simulated sensor data and to take account of the simulated sensor data when actuating the first simulation and/or the second simulation.

4: The method according to claim 1, wherein the technical device is a robot belonging to at least one of the following categories:
a vehicle;
a robot arm;
a robot for positioning or attaching material and/or objects;
a robot for cleaning surfaces;
a robot for examining spaces or surfaces;
a robot for applying a chemical; or
a robot for carrying out a medical intervention.

5: The method according to claim 4, wherein the first training goal belongs to at least one of the following categories of training goals:
a stretch traveled on a virtual training course or a virtual test route;
a number of movement patterns carried out without any collisions or within a predefined movement range;
a time period within which the neural network actuates the first simulation properly and without any undesired events occurring; or
a threshold value being reached for a reward function.

6: The method according to claim 1, wherein the second simulation:
takes account of more mechanical and/or electrical components of the technical device than the first simulation;
takes account of more degrees of mechanical freedom than the first simulation;
simulates physical phenomena and/or laws in a more realistic manner and/or to a higher degree of accuracy than the first simulation;
takes account of a larger number of physical forces and/or interactions than the first simulation; and/or
has a smaller simulation step size than the first simulation.

7: The method according to claim 1, further comprising:
setting a second training goal for an actuation of the second simulation;
during the actuation of the second simulation, checking the training progress of the neural network against the second training goal;
establishing a physical data link between the neural network and the technical device based on the second training goal having been achieved; and
the neural network actuating the technical device.

8: A system, comprising:
at least one processor; and
at least one memory having instructions stored thereon;
wherein the at least one processor is configured to execute the instructions stored on the at least one memory to provide a virtual training environment for training a neural network for actuating a technical device, the virtual training environment comprising:
a first simulation of the technical device having a first data interface for reading out status data from the first simulation and transferring control data to the first simulation;
a programming interface for establishing a first data link between the neural network and the first simulation;
a training functionality configured to set a training goal for the first simulation to be actuated by the neural network and to check the training progress of the neural network against the training goal; and
a second simulation of the technical device, wherein the second simulation is configured to be more realistic than the first simulation and requires more mathematical operations than the first simulation for a respective simulation cycle owing to its higher degree of realism, and wherein the second simulation comprises a second data interface for reading out status data from the second simulation and transferring control data to the second simulation;
wherein the training functionality is configured to:
break the first data link based on the training goal having been achieved;
replace the first data link with a second data link between the neural network and the second simulation; and
train the neural network based on the second simulation being actuated by the neural network.

9: The system according to claim 8, wherein the first data interface and the second data interface are configured identically.

10: The system according to claim 8, wherein the virtual training environment comprises a virtual environment of the technical device and a sensor simulation; and
wherein the virtual training environment is configured to:
generate simulated sensor data via the sensor simulation, wherein the simulated sensor data contain information on the virtual environment; and
transmit the simulated sensor data to the neural network via the programming interface.

11: The system according to claim 8, wherein the technical device is a robot belonging to at least one of the following categories:
a vehicle;
a robot arm;
a robot for positioning or attaching material and/or objects;
a robot for cleaning surfaces;
a robot for examining spaces or surfaces;
a robot for applying a chemical; or
a robot for carrying out a medical intervention.

12: The system according to claim 11, wherein the training goal belongs to at least one of the following categories of training goals:
a stretch traveled on a virtual training course or a virtual test route;
a number of movement patterns carried out without any collisions or within a predefined movement range;
a time period within which the neural network actuates the first simulation properly and without any undesired events occurring; or
a threshold value being reached for a reward function.

13: The system according to claim 8, wherein the second simulation:
takes account of more mechanical and/or electrical components of the technical device than the first simulation;
takes account of more degrees of mechanical freedom than the first simulation;
simulates physical phenomena and/or laws in a more realistic manner and/or to a higher degree of accuracy than the first simulation;
takes account of a larger number of physical forces and/or interactions than the first simulation; and/or
has a smaller simulation step size than the first simulation.
